(19) United States
(12) Patent Application Publication
(10) Pub. No.: US 2013/0077025 A1
(43) Pub. Date: Mar. 28, 2013

(54) BACKLIGHT MODULE AND LIQUID CRYSTAL DISPLAY DEVICE USING THE SAME

(71) Applicants: Shih-Hsiang Chen, Shenzhen (CN); Yu-Bo Gu, Shenzhen (CN); Dan Xiao, Shenzhen (CN); Liu-Yang Yang, Shenzhen (CN)

(72) Inventors: Shih-Hsiang Chen, Shenzhen (CN); Yu-Bo Gu, Shenzhen (CN); Dan Xiao, Shenzhen (CN); Liu-Yang Yang, Shenzhen (CN)

(21) Appl. No.: 13/377,978

(22) PCT Filed: Oct. 10, 2011
(86) PCT No.: PCT/CN2011/080611

§ 371 Date: Dec. 13, 2011

(30) Foreign Application Priority Data
Sep. 22, 2011 (CN) 201110284567.2

(51) Int. Cl. G02F 1/1335; G09F 13/04

(52) U.S. Cl. 349/64; 362/97.2

(57) ABSTRACT

A backlight module and a liquid crystal display device using the same are provided. The backlight module comprises a back plate, and an upper surface of the back plate is an uneven surface. The uneven surface is composed of a plurality of protruded portions and a plurality of indented portions formed on the upper surface of the back plate; or, the uneven surface is composed of a matte surface formed on the upper surface of the back plate. A light emitting source coordinating with the back plate is disposed above the back plate, and faces the uneven surface to emit light.

### FIELD OF THE INVENTION

The present invention relates to a liquid crystal display device and more particularly to a backlight module structure of a liquid crystal display device.

### BACKGROUND OF THE INVENTION

A liquid crystal display device employs liquid crystals to display images. Typically, it is composed of a liquid crystal panel, a backlight module, related digital circuits and a power supply. The backlight module can be divided into three types in terms of a position of a light tube: 1) Edge type structure which a light source is disposed by a lateral side of a light guide plate; 2) Direct type structure which light is emitted from a spontaneous light source and is reflected by a reflecting plate to travel upward, and is emitted from a front after it is diffused evenly by a diffusing plate; 3) Hollow type structure which a hot-cathode tube is used as a light source, this structure uses air as a media for light. A light source pointed downward and after its direction is adjusted and reflected by a prism and a reflecting plate, a part of the light travels upward to go through a light guide plate and is emitted from its surface, another part of the light enters into a cavity again because of total reflection, then is emitted through the light guide plate after being refracted and reflected. A light source pointed upward enters into the light guide plate and is emitted directly, or is emitted after refractions and reflections. In addition, the light guide plate is a wedge structure.

A conventional direct type backlight module employs LED as a light source, and the LED is mostly disposed right below a liquid crystal panel and emits light toward the panel. Because light beam emitted from the LED is too concentrated and causes unevenly distributed brightness (hot spot or spotlight effect) when pictures are shown by the liquid crystal display device. In order to reduce the occurrence of pictures with unevenly distributed brightness, a plurality of diffusing sheets is commonly used for improvement. For example, Taiwanese patent number 1338801 discloses a direct type backlight module as shown in FIG. 1, and differences between it and other common direct type backlight modules lie in: it comprises a plurality of reflecting structures 104, and the reflecting structures 104 are disposed at corners defined by a back plate 101 and a frame 10, which are used to avoid dimmed straps formed at corners or edges of the backlight module, so that a brightness of the backlight module is more even. The reflecting structures 104 can be made of silver or white polyester resin (PET), or a combination thereof. The reflecting structures 104 and the back plate 101 can be formed in one body, or the reflecting structures 104, the back plate 101 and the frame 102 can be formed in one body. This conventional structure has a problem with unevenly distributed brightness which needs to be solved with a better solution, and a combination of the reflecting structures and the back plate is rather structurally complicated which is more troublesome for manufacturing.

### SUMMARY OF THE INVENTION

An object of the present invention is to provide a backlight module structure of a liquid crystal display device by which a problem with unevenly distributed brightness can be solved more effectively and is easy for manufacturing.

In order to achieve the abovementioned object, the present invention provides a backlight module of a liquid crystal display device which comprises a back plate, an upper surface of the back plate is an uneven surface.

In order to achieve the abovementioned object, the present invention further provides a liquid crystal display device, and it comprises a panel and the abovementioned backlight module disposed below the panel.

Comparing with conventional techniques and according to a backlight module and a liquid crystal display device using the same of the present invention, by using the uneven surface as the upper surface of the back plate, the problem with unevenly distributed brightness can be solved more effectively and is easy for manufacturing.

### BRIEF DESCRIPTION OF THE DRAWINGS

FIG. 1 is an exploded perspective view of a conventional liquid crystal display device and its backlight module; and

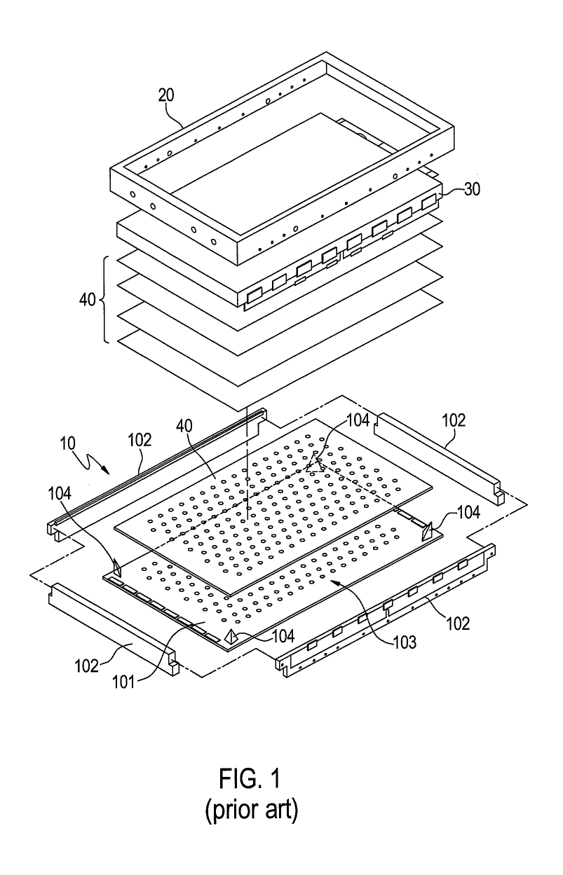

FIG. 2 is a structural illustration of a liquid crystal display device and its backlight module of an embodiment according to the present invention.

### DETAILED DESCRIPTION OF THE INVENTION

The present invention will become more fully understood by reference to the following detailed description thereof when read in conjunction with the attached drawings.

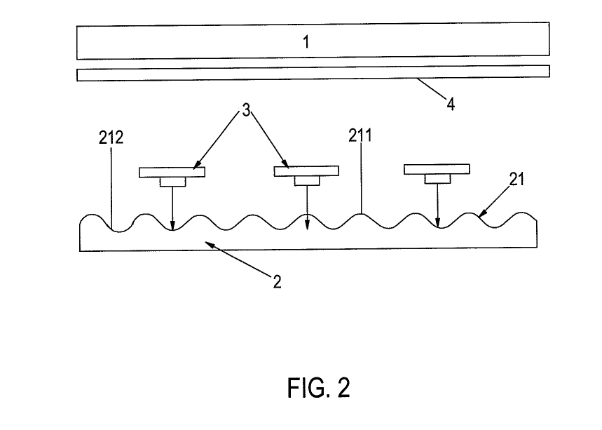

Referring to FIG. 2, a liquid crystal display device and its backlight module of an embodiment of the present invention mainly comprises: a liquid crystal panel 1, a back plate 2, a light emitting source 3 and a diffusing sheet 4.

An upper surface of the back plate 2 is an uneven surface 21. The uneven surface 21 is composed of a plurality of protruded portions 211 and indented portions 212 formed on the upper surface of the back plate 2. Wherein, preferably, a plurality of the protruded portions 211 and the indented portions 212 can be arranged abreast of each other in a corrugation of a plurality of the strip-shaped protruded portions 211 as well as the strip-shaped indented portions 212, and they can also be arranged in an array of a plurality of the dot-shaped protruded portions 211 as well as the dot-shaped indented portions 212.

The light emitting source 3 is disposed above the back plate 2. Preferably, the light emitting source 3 is a LED, and the LED faces the uneven surface 21 to emit light.

The diffusing sheet 4 is disposed between the light emitting source 3 and the liquid crystal panel 1. A light transmitted from the uneven surface 21 of the back plate 2 is diffused evenly by the diffusing sheet 4 and is emitted from its front surface which is also its upper surface, in order to provide a backlight required for displaying by the liquid crystal panel 1.

Comparing with existing techniques, advantages of a liquid crystal display device and its backlight module of the present invention include: by having the upper surface of the back plate formed as the uneven surface, and by having the LEDs to emit light toward the uneven surface, the light emitted from the LEDs can be diffused by the uneven surface so that the backlight can be distributed more evenly, furthermore, the uneven surface can be formed easily, therefore it is easier for formation of the liquid crystal display device and its backlight module.

Note that the specifications relating to the above preferred embodiment should be construed as exemplary rather than as limitative of the present invention, with many variations and modifications of the description and the accompanying drawings disclosed above, for example, having the regularly arranged structure of the protruded portions 211 and the indented portions 212 of the uneven surface 21 replaced by irregularly arranged matte surfaces, are defined by the appended claims and their legal equivalents.

1.-10. (canceled)

11. A backlight module of a liquid crystal display device comprising:
a back plate, wherein an upper surface of the back plate is an uneven surface.

12. The backlight module of a liquid crystal display device as claimed in claim 11, wherein the uneven surface is composed of a plurality of protruded portions and a plurality of indented portions formed on the upper surface of the back plate.

13. The backlight module of a liquid crystal display device as claimed in claim 12, wherein the uneven surface is composed of a plurality of strip-shaped protruded portions and a plurality of strip-shaped indented portions arranged in a corrugation formed on the upper surface of the back plate.

14. The backlight module of a liquid crystal display device as claimed in claim 12, wherein the uneven surface is composed of a plurality of dot-shaped protruded portions and a plurality of dot-shaped indented portions arranged in an array arrangement formed on the upper surface of the back plate.

15. The backlight module of a liquid crystal display device as claimed in claim 11, wherein the uneven surface is composed of a matte surface formed on the upper surface of the back plate.

16. The backlight module of a liquid crystal display device as claimed in claim 11, wherein the backlight module further comprises a light emitting source coordinating with the back plate, and the light emitting source is disposed above the back plate.

17. The backlight module of a liquid crystal display device as claimed in claim 16, wherein the light emitting source faces the uneven surface to emit light.

18. The backlight module of a liquid crystal display device as claimed in claim 16, wherein the light emitting source is a LED.

19. The backlight module of a liquid crystal display device as claimed in claim 16, wherein the backlight module further comprises a diffusing sheet coordinating with the back plate, the diffusing sheet is disposed above the light emitting source.

20. A liquid crystal display device comprising:
a panel; and
a backlight module as claimed in claim 1 disposed below the panel.

21. The liquid crystal display device as claimed in claim 20, wherein the uneven surface is composed of a plurality of protruded portions and a plurality of indented portions formed on the upper surface of the back plate.

22. The liquid crystal display device as claimed in claim 21, wherein the uneven surface is composed of a plurality of strip-shaped protruded portions and a plurality of strip-shaped indented portions arranged in a corrugation formed on the upper surface of the back plate.

23. The liquid crystal display device as claimed in claim 21, wherein the uneven surface is composed of a plurality of dot-shaped protruded portions and a plurality of dot-shaped indented portions arranged in an array arrangement formed on the upper surface of the back plate.

24. The liquid crystal display device as claimed in claim 20, wherein the uneven surface is composed of a matte surface formed on the upper surface of the back plate.

25. The liquid crystal display device as claimed in claim 20, wherein the backlight module further comprises a light emitting source coordinating with the back plate, and the light emitting source is disposed above the back plate.

26. The liquid crystal display device as claimed in claim 25, wherein the light emitting source faces the uneven surface to emit light.

27. The liquid crystal display device as claimed in claim 25, wherein the light emitting source is a LED.

28. The liquid crystal display device as claimed in claim 25, wherein the backlight module further comprises a diffusing sheet coordinating with the back plate, the diffusing sheet is disposed above the light emitting source.
